(19) United States
(12) Patent Application Publication
(10) Pub. No.: US 2024/0116288 A1
(43) Pub. Date: Apr. 11, 2024

(54) ELECTRIC AUTOMATIC HEAT TRANSFER MACHINE

(71) Applicant: Dongguan Yifei Thermal Transfer Printing Technology Co., LTD., Dongguan City (CN)

(72) Inventor: Zhiyong Zhang, Xiaogan City (CN)

(21) Appl. No.: 17/980,264

(22) Filed: Nov. 3, 2022

(30) Foreign Application Priority Data
Oct. 9, 2022 (CN) 202211224946.7

(51) Int. Cl. B41F 16/00

(52) U.S. Cl. CPC B41F 16/0046; B41F 16/0086; B44C 1/1729

(57) ABSTRACT

The present disclosure belongs to the technical field of heat transfer printing, and in particular relates to an electric automatic heat transfer machine. The electric automatic heat transfer machine comprises a main machine base and a main frame; the upper end face of the main machine base is provided with a hot stamping table; the main frame is provided on the upper end face of the main machine base, the free end of the main frame is located above the hot stamping table, and there is a working gap between the free end of the main frame and the hot stamping table; the main frame is provided with a controller and an electric drive device, an action end of the electric drive device is located above the hot stamping table, and the action end of the electric drive device is provided with a heating plate; and the controller is electrically connected with the electric drive device and the heating plate. The electric automatic heat transfer machine uses the electric drive device as the power source, so that the structure of the electric automatic heat transfer machine is simpler and lighter, and the use cost and production cost thereof are reduced. At the same time, the electric drive device is provided in the main frame to reduce the volume and occupied space of the electric automatic heat transfer machine, so that it is more convenient to use the electric automatic heat transfer machine.

### TECHNICAL FIELD

The present disclosure belongs to the technical field of heat transfer printing, and particularly relates to an electric automatic heat transfer machine.

### BACKGROUND

A heat transfer machine can perform heat transfer printing on various pyrographs on cotton, hemp, chemical fiber and other fabrics, and can perform heat treatment such as screen printing, mucilage, foaming, etc. The heat transfer machine can also bake color codes, portrait photos, landscape patterns, etc. on porcelain plates and metal plates, which is especially suitable for making medals, commemorative cards, cultural shirts, etc. The heat transfer machine is economical and practical, and has exquisite patterns. The heat transfer machine is replacing traditional embroidery and screen printing, the effect of which is better than general embroidery and multi-color screen printing, and the cost of which is lower.

Most of the existing hat baking machines are manual heat transfer, cylinder heat transfer or hydraulic heat transfer, in which manual heat transfer is laborious and inefficient, and at the same time, the low pressure is not enough to achieve high-quality hot stamping; both pneumatic heat transfer products and hydraulic heat transfer products need to be provided with additional auxiliary devices such as an air pump, an oil pump, an oil storage tank or an air reservoir to make the cylinder or oil cylinder of the hat baking machine work. As a result, the existing pneumatic hat baking machines and hydraulic hat baking machines are bulky, heavy and noisy, and at the same time, the cost of the pneumatic or hydraulic hat baking machines increases. Therefore, providing a hat baking machine with small volume, light weight and low cost is a technical problem to be solved urgently by those skilled in the art.

### SUMMARY

In order to solve the above problems in the prior art, the present disclosure provides an electric automatic heat transfer machine to solve the technical problems of large volume, heavy weight and high cost of the pneumatic or hydraulic hat baking machines in the prior art.

The present disclosure is specifically realized by the following technical scheme.

An electric automatic heat transfer machine is provided, comprising a main machine base and a main frame;
the upper end face of the main machine base is provided with a hot stamping table;
the main frame is provided on the upper end face of the main machine base, the free end of the main frame is located above the hot stamping table, there is a working gap between the free end of the main frame and the hot stamping table; the main frame is provided with a controller and an electric drive device, an action end of the electric drive device is located above the hot stamping table, and the action end of the electric drive device is provided with a heating plate, and the electric drive device is capable of driving the heating plate to act towards or away from the hot stamping table; and the controller is electrically connected with the electric drive device and the heating plate.

In order to achieve the present disclosure better, the above structure is further optimized, an accommodating cavity is provided in the main frame, the bottom of the main frame is provided with an opening communicated with the accommodating cavity, the electric drive device is located in the accommodating cavity, and the bottom of the electric drive device is fixedly connected with the main machine base.

In order to achieve the present disclosure better, the above structure is further optimized, the electric drive device comprises a driving body and a connecting rod, the middle of the connecting rod is hinged to the main frame, the fixed end of the connecting rod is connected with the lifting end of the driving body, and the movable end of the connecting rod is hinged with the heating plate.

In order to achieve the present disclosure better, the above structure is further optimized, a support bracket for supporting the hot stamping table is provided on the main machine base, and the hot stamping table is detachably provided on the support bracket.

In order to achieve the present disclosure better, the above structure is further optimized, the support bracket is provided with a fixed support and a tension spring, the middle of the fixed support is hinged on the side wall of the support bracket, and one end of the tension spring far away from the support bracket is connected with the pulling end of the fixed support.

In order to achieve the present disclosure better, the above structure is further optimized, the electric automatic heat transfer machine further comprises a fixed support, a tension spring and a sleeve, wherein the middle of the sleeve is hinged on the side wall of the support bracket, the rotation center line of the sleeve is perpendicular to the side wall of the support bracket, the rotation center line of the sleeve is perpendicular to the axis of the sleeve, the fixed support is inserted into the sleeve so that the fixed support is slidable along the axis of the sleeve; the fixed end of the tension spring is connected with the bottom of the support bracket, and the movable end of the tension spring is connected with one end of the sleeve close to the fixed end of the fixed support.

In order to achieve the present disclosure better, the above structure is further optimized, the working surface of the hot stamping table is a convex arc surface, and the working surface of the heating plate is a concave arc surface matched with the working surface of the hot stamping table.

In order to achieve the present disclosure better, the above structure is further optimized, the lower end face of the main machine base is provided with a supporting leg.

In order to achieve the present disclosure better, the above structure is further optimized, a screw is provided on the supporting leg, a screw hole matched with the screw is provided on the lower end face of the main machine base, and the supporting leg is provided on the main machine base through the matching of the screw and the screw hole.

In order to achieve the present disclosure better, the above structure is further optimized, the electric automatic heat transfer machine is a hat baking machine, a tray baking machine or a cup baking machine.

To sum up, the present disclosure has the following technical effects.

The electric automatic heat transfer machine uses the electric drive device as the power source without other auxiliary devices, so that the structure of the electric automatic heat transfer machine is simpler and lighter, and the use cost and production cost thereof are reduced. At the same time, the electric drive device is provided in the main frame to reduce the volume and occupied space of the electric automatic heat transfer machine, so that it is more convenient to use the electric automatic heat transfer machine.

### BRIEF DESCRIPTION OF THE DRAWINGS

In order to explain the embodiments of the present disclosure or the technical schemes in the prior art more clearly, the drawings that need to be used in the description of the embodiments or the prior art will be briefly introduced hereinafter. Obviously, the drawings in the following description are only some embodiments of the present disclosure. For those skilled in the art, other drawings can be obtained according to these drawings without any creative effort.

FIG. 1 is a schematic structural diagram of an electric automatic heat transfer machine according to Embodiment 1 as a hat baking machine.

FIG. 2 is a cross-sectional view of an electric automatic heat transfer machine according to Embodiment 1.

FIG. 3 is a schematic structural diagram of an electric automatic heat transfer machine according to Embodiment 1 as a cup baking machine.

FIG. 4 is a schematic structural diagram of an electric automatic heat transfer machine according to Embodiment 1 as a tray baking machine.

FIG. 5 is a schematic structural diagram of an electric automatic heat transfer machine according to Embodiment 2.

### REFERENCE NUMBER

1, main machine base; 11, hot stamping table; 12, support bracket; 13, fixed support; 14, tension spring; 15, supporting leg; 16, sleeve;
2, main frame; 21, electric drive device; 211, driving body; 212, connecting rod; 22, accommodation cavity; 23, heating plate; 24, controller.

### DETAILED DESCRIPTION OF THE EMBODIMENTS

In order to make the object, technical scheme and advantages of the present disclosure clearer, the technical scheme of the present disclosure will be described in detail hereinafter. Obviously, the described embodiments are only part of the embodiments of the present disclosure, rather than all of the embodiments. Based on the embodiment of the present disclosure, all other embodiments obtained by those skilled in the art without any creative effort belong to the scope of protection of the present disclosure.

In the description of the present disclosure, it should be noted that, unless otherwise stated, “a plurality of” means two or more; the orientational or positional relationships indicated by the terms such as “up”, “down”, “left”, “right”, “inside”, “outside”, “front end”, “back end”, “head” and “tail” are based on the orientational or positional relationships shown in the drawings only for the convenience of describing the present disclosure and simplifying the description, rather than indicate or imply that the referred devices or elements must have a specific orientation, be constructed and operated in a specific orientation, and therefore should not be construed as limiting the present disclosure. In addition, the terms such as “first”, “second” and “third” are only used for the purpose of description, and cannot be understood as indicating or implying relative importance.

In the description of the present disclosure, it should also be noted that unless otherwise specified and defined expressly, the terms such as “mount”, “link” and “connect” should be understood broadly, for example, it can be fixed connection, detachable connection or integral connection; or mechanical connection or electrical connection; or direct connection or indirect connection through an intermediate medium. For those skilled in the art, the specific meanings of the above terms in the present disclosure can be understood according to specific situations.

### Embodiment 1

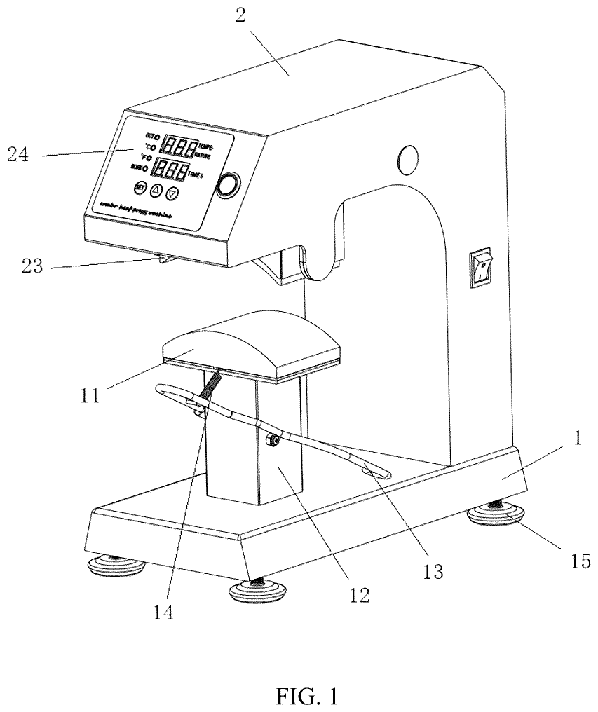

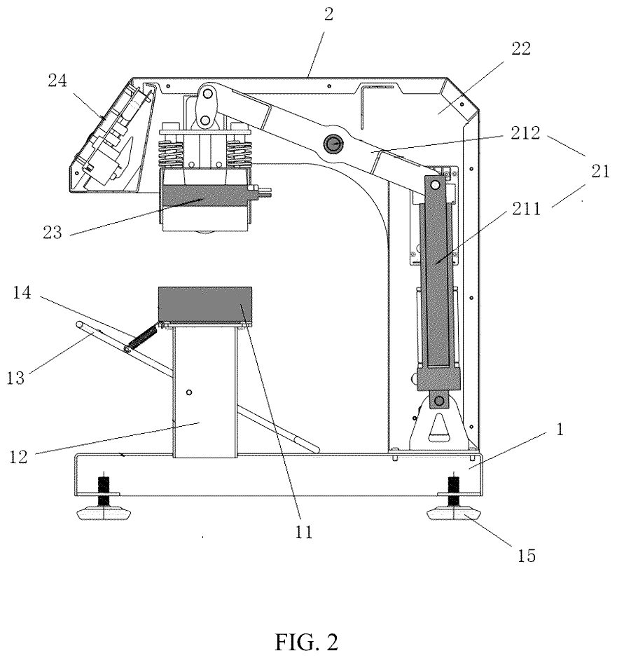

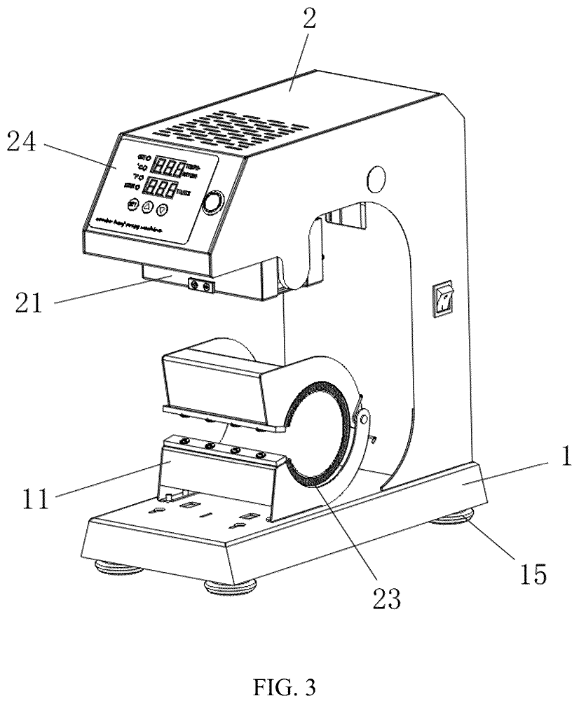

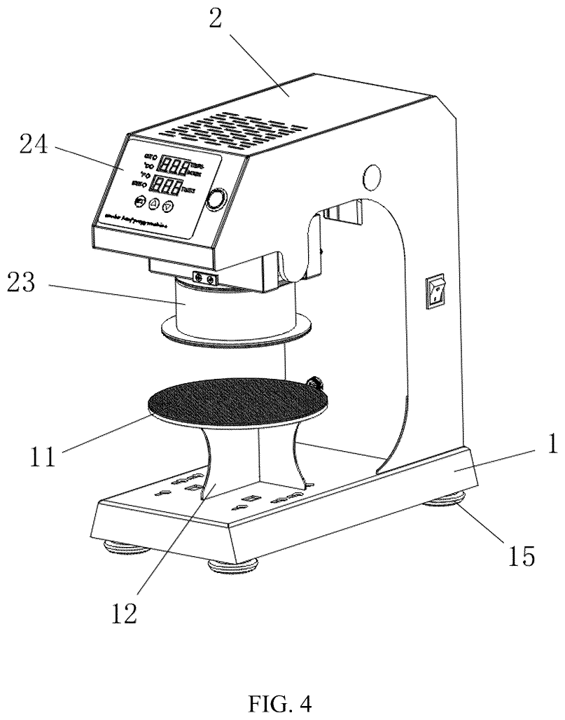

As shown in FIG. 1, FIG. 2, FIG. 3 and FIG. 4:
an electric automatic heat transfer machine comprises a main machine base 1 and a main frame 2; wherein
the upper end face of the main machine base 1 is provided with a hot stamping table 11;
the main frame 2 is provided on the upper end face of the main machine base 1, the free end of the main frame 2 is located above the hot stamping table 11, there is a working gap between the free end of the main frame 2 and the hot stamping table 11; the main frame 2 is provided with a controller 24 and an electric drive device 21, an action end of the electric drive device 21 is located above the hot stamping table 11, and the action end of the electric drive device 21 is provided with a heating plate 23, and the electric drive device 21 is capable of driving the heating plate 23 to act towards or away from the hot stamping table 11 in the working gap;
the controller 24 is electrically connected with the electric drive device 21 and the heating plate 23.

The automatic heat transfer machine can be a hat baking machine, a cup baking machine, a tray baking machine, or a two-in-one heat transfer machine integrating a tray baking machine and a hat baking machine, an automatic two-in-one heat transfer machine, an automatic three-in-one heat transfer machine, an automatic five-in-one heat transfer machine or an automatic fifteen-in-one heat transfer machine, etc., all of which use an electric drive device 21 to drive the heating plate 23 to act towards the hot stamping table 11 to complete the hot stamping. This embodiment takes the hat baking machine as an example.

When using a hat baking machine, workers can turn on the power supply of the hat baking machine, set the required time and temperature of hot stamping through the controller 24, and at the same time, start the heating plate 23, so that the working surface of the heating plate 23 starts to raise the temperature.

After the temperature of the working surface of the heating plate 23 reaches the set temperature, the workers can place the hat needing hot stamping patterns on the hot stamping table 11. The part of the hat that needs hot stamping is located on the hot stamping table 11, and the hot stamping surface of the hat faces the working surface of the heating plate 23.

Then, the hot stamping picture with patterns can be covered on the hot stamping surface and is fixed on the hat with a high-temperature adhesive tape. Then, the controller 24 controls the electric drive device 21 to act, so that the electric drive device 21 drives the heating plate 23 to move towards the hot stamping table 11, and the heating plate 23 tightly presses the hot stamping picture and the hat on the hot stamping table 11 for hot stamping.

After the set time is reached, the controller 24 will automatically control the electric drive device 21 to act, so that the electric drive device 21 drives the heating plate 23 to move away from the hot stamping table 11 so as to finish the hot stamping of the pattern on the hat.

The electric automatic heat transfer machine uses the electric drive device 21 as the power source without other auxiliary devices, so that the structure of the electric automatic heat transfer machine is simpler and lighter, and the use cost and production cost thereof are reduced. At the same time, the electric drive device 21 is provided in the main frame 2 to reduce the volume and occupied space of the electric automatic heat transfer machine, so that it is more convenient to use the electric automatic heat transfer machine.

In addition, the working noise of the electric drive device 21 is lower, so as to reduce the burden and injury of the workers during work.

Preferably, an accommodating cavity 22 is provided in the main frame 2; wherein
the bottom of the main frame 2 is provided with an opening communicated with the accommodating cavity 22, and the electric drive device 21 is located in the accommodating cavity 22, so that the structure of the electric automatic heat transfer machine is simpler and lighter.

Moreover, the bottom of the electric drive device 21 is fixedly connected with the main machine base 1, so that the structure of the electric automatic heat transfer machine is more stable.

Preferably, the electric drive device 21 comprises a driving body 211 and a connecting rod 212; wherein
the driving main body 211 is fixedly provided on the main machine base 1 by screws or bolts, and the action end of the driving main body 211 can move upward or downward vertically.

The connecting rod 212 is located above the driving body 211. The middle of the connecting rod 212 is hinged to the main frame 2. The fixed end of the connecting rod 212 is connected with the lifting end of the driving body 211, and the movable end of the connecting rod 212 is hinged with the heating plate 23.

When the action end of the driving body 211 moves upward, the driving body 211 can drive the heating plate 23 to move towards the hot stamping table 11 through the connecting rod 212. When the action end of the driving body 211 moves downward, the driving body 211 can drive the heating plate 23 to move away from the hot stamping table 11 through the connecting rod 212, so as to better realize the automatic hot stamping of the electric automatic heat transfer machine.

Preferably, a support bracket 12 for supporting the hot stamping table 11 is provided on the main machine base 1, and the hot stamping table 11 is detachably provided on the support bracket 12, so that the hat can be placed more conveniently.

Preferably, the support bracket 12 is provided with a fixed support 13 and a tension spring 14; wherein
the middle of the fixed support 13 is hinged on the side wall of the support bracket 12, and one end of the tension spring 14 far away from the support bracket 12 is connected with the pulling end of the fixed support 13, so that the fixed end of the fixed support 13 is always located at one end of the support bracket 12 far away from the hot stamping table 11 without an external force.

When hot stamping is required, the workers can pull the pulling end of the fixed support 13 away from the hot stamping table 11, and the fixed end of the fixed support 13 moves towards the hot stamping table 11. At this time, the workers can buckle the hat on the hot stamping table 11 and the fixed end of the fixed support 13.

Then, the workers can release the fixed support 13, and the pulling end of the fixed support 13 moves towards the hot stamping table 11 under the action of the tension spring 14, while the fixed end of the fixed support 13 pulls one end of the hat away from the hot stamping table 11, so that the hat can be firmly clamped on the hot stamping table 11, thus preventing the hat from falling off the hot stamping table during the hot stamping, and making it more convenient to use the electric automatic heat transfer machine.

Preferably, the working surface of the hot stamping table 11 is a convex arc surface, and the working surface of the heating plate 23 is a concave arc surface matched with the working surface of the hot stamping table 11, so as to better realize the hot stamping of curved or irregular plane objects, thus making it more convenient to use the electric automatic heat transfer machine.

Preferably, the lower end face of the main machine base 1 is provided with a supporting leg 15.

Specifically, a screw is provided on the supporting leg 15, a screw hole matched with the screw is provided on the lower end face of the main machine base 1, and the supporting leg 15 is provided on the main machine base 1 through the matching of the screw and the screw hole.

When it is necessary to adjust the height of the electric automatic heat transfer machine, the workers can adjust the distance between the supporting leg 15 and the main machine base 1 by screwing the supporting leg 15, so as to realize the height adjustment of the electric automatic heat transfer machine and make it more convenient to use the electric automatic heat transfer machine.

In addition, in the case that the mounting surface of the electric automatic heat transfer machine is uneven, the workers can also place the electric automatic heat transfer machine on the mounting surface stably by adjusting the length of each supporting leg 15.

### Embodiment 2

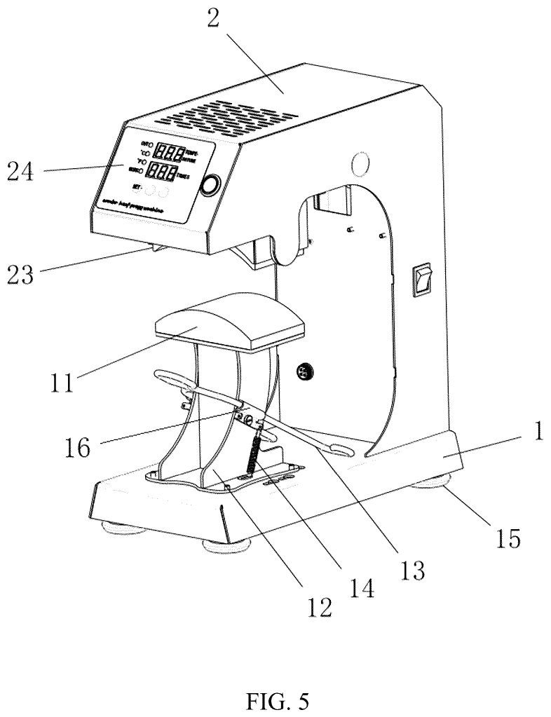

As shown in FIG. 3 and FIG. 5:

As another implementation of Embodiment 1, the fixed support 13 can be mounted and fixed on the support bracket 12 in the following manner.

The side wall of the support bracket 12 is provided with a sleeve 16. The middle of the sleeve 16 is hinged on the support bracket 12. The rotation center line of the sleeve 16 is perpendicular to the side wall of the support bracket 12, and the rotation center line of the sleeve 16 is perpendicular to the axis of the sleeve 16. The fixed support 13 is inserted into the sleeve 16 so that the fixed support 13 is slidable along the axis of the sleeve 16;
the fixed end of the tension spring 14 is connected with the bottom of the support bracket 12, and the movable end of the tension spring 14 is connected with one end of the sleeve 16 close to the fixed end of the fixed support 13.

The workers can adjust the position of the fixed end of the fixed support 13 by swinging the fixed support 13 up and down or pulling the fixed support 13 back and forth, so as to better fix the hat, thus making it more convenient to use the electric automatic heat transfer machine.

In addition, other structures of the electric automatic heat transfer machine according to this embodiment are completely the same as those of the electric automatic heat transfer machine according to Embodiment 1. For details, refer to the contents of Embodiment 1, which will not be described in detail here.

The above are only the specific embodiments of the present disclosure, but the scope of protection of the present disclosure is not limited thereto. Any changes or substitutions conceivable to those skilled in the art within the technical scope disclosed by the present disclosure should be covered by the scope of protection of the present disclosure. Therefore, the scope of protection of the present disclosure should be based on the scope of protection of the claims.

What is claimed is:

1. An electric automatic heat transfer machine, comprising a main machine base (2) and a main frame (1);
the upper end face of the main machine base (1) is provided with a hot stamping table (11);
the main frame (2) is provided on the upper end face of the main machine base (1), the free end of the main frame (2) is located above the hot stamping table (11), there is a working gap between the free end of the main frame (2) and the hot stamping table (11); the main frame (2) is provided with a controller (24) and an electric drive device (21), an action end of the electric drive device (21) is located above the hot stamping table (11), and the action end of the electric drive device (21) is provided with a heating plate (23), and the electric drive device (21) is capable of driving the heating plate (23) to act towards or away from the hot stamping table (11); and the controller (24) is electrically connected with the electric drive device (21) and the heating plate (23).

2. The electric automatic heat transfer machine according to claim 1, wherein an accommodating cavity (22) is provided in the main frame (2), the bottom of the main frame (2) is provided with an opening communicated with the accommodating cavity (22), the electric drive device (21) is located in the accommodating cavity (22), and the bottom of the electric drive device (21) is fixedly connected with the main machine base (1).

3. The electric automatic heat transfer machine according to claim 2, wherein the electric drive device (21) comprises a driving body (211) and a connecting rod (212), the middle of the connecting rod (212) is hinged to the main frame (2), the fixed end of the connecting rod (212) is connected with the lifting end of the driving body (211), and the movable end of the connecting rod (212) is hinged with the heating plate (23).

4. The electric automatic heat transfer machine according to claim 1, wherein a support bracket (12) for supporting the hot stamping table (11) is provided on the main machine base (1), and the hot stamping table (11) is detachably provided on the support bracket (12).

5. The electric automatic heat transfer machine according to claim 4, wherein the support bracket (12) is provided with a fixed support (13) and a tension spring (14), the middle of the fixed support (13) is hinged on the side wall of the support bracket (12), and one end of the tension spring (14) far away from the support bracket (12) is connected with the pulling end of the fixed support (13).

6. The electric automatic heat transfer machine according to claim 4, further comprising a fixed support (13), a tension spring (14) and a sleeve (16), wherein the middle of the sleeve (16) is hinged on the side wall of the support bracket (12), the rotation center line of the sleeve (16) is perpendicular to the side wall of the support bracket (12), the rotation center line of the sleeve (16) is perpendicular to the axis of the sleeve (16), the fixed support (13) is inserted into the sleeve (16) so that the fixed support (13) is slidable along the axis of the sleeve (16); the fixed end of the tension spring (14) is connected with the bottom of the support bracket (12), and the movable end of the tension spring (14) is connected with one end of the sleeve (16) close to the fixed end of the fixed support (13).

7. The electric automatic heat transfer machine according to claim 1, wherein the working surface of the hot stamping table (11) is a convex arc surface, and the working surface of the heating plate (23) is a concave arc surface matched with the working surface of the hot stamping table (11).

8. The electric automatic heat transfer machine according to claim 1, wherein the lower end face of the main machine base (1) is provided with a supporting leg (15).

9. The electric automatic heat transfer machine according to claim 8, wherein a screw is provided on the supporting leg (15), a screw hole matched with the screw is provided on the lower end face of the main machine base (1), and the supporting leg (15) is provided on the main machine base (1) through the matching of the screw and the screw hole.

10. The electric automatic heat transfer machine according to claim 1, wherein the electric automatic heat transfer machine is a hat baking machine, a tray baking machine or a cup baking machine.
